(19) United States
(12) Patent Application Publication
(10) Pub. No.: US 2016/0065430 A1
(43) Pub. Date: Mar. 3, 2016

(54) MONITORING APPARATUS AND METHOD THEREOF

(71) Applicant: CANON KABUSHIKI KAISHA, Tokyo (JP)

(72) Inventor: Akiko Hirahara, Kawasaki-shi (JP)

(21) Appl. No.: 14/825,007

(22) Filed: Aug. 12, 2015

(30) Foreign Application Priority Data
Aug. 27, 2014 (JP) 2014-172785

(51) Int. Cl. H04L 12/26

(52) U.S. Cl. CPC H04L 43/065; H04L 43/0823; H04L 43/50

(57) ABSTRACT

A monitoring apparatus includes an acquisition unit, a monitoring unit, first and second transmission units, a generation unit, and a stop unit. The acquisition unit acquires a list including network devices to be a monitoring target from a management apparatus that manages network devices registration information. The monitoring unit acquires device information from the network devices included in the list and performs monitoring processing. The first transmission unit transmits at least a part of the acquired device information to the management apparatus. The generation unit generates, in a case where a network device satisfying a predetermined condition is identified according to a monitoring processing result, failure information as failure of the identified network device. The second transmission unit transmits the generated failure information to the management apparatus. The stop unit stops the monitoring processing for the network device corresponding to the generated failure information based on the predetermined condition.

### BACKGROUND OF THE INVENTION

1. Field of the Invention

The present invention relates to a control for a monitoring apparatus that monitors network devices.

2. Description of the Related Art

There is a conventional device management system that can remotely monitor operating conditions of a target device, such as an image forming apparatus (e.g., a printer or a multi-function peripheral). The device management system includes a monitoring apparatus installed on each client apparatus and a central management apparatus connected to the monitoring apparatus via the internet. Each monitoring apparatus can transmit collected device data to the central management apparatus by using an appropriate network protocol (e.g., HTTPS or SMTP). The central management apparatus manages the received device data in a centralized fashion. The central management apparatus totally manages information about each client with which a maintenance contract has been exchanged, together with monitoring apparatus information and monitoring target device information. In response to monitoring information transmitted from a registered monitoring apparatus, the central management apparatus stores the transmitted data.

In general, monitoring apparatuses can be classified into various types. For example, there is a monitoring apparatus configured to acquire a device list (i.e., a list including devices registered thereto) together with device information from the central management apparatus and start a monitoring operation. According to the above-mentioned system configuration, the operation usually performed by the monitoring apparatus includes regularly acquiring the registered device list together with device information from the central management apparatus. The device information includes information required to communicate with a target device or information required to identify a target device, such as IP address, host name, device serial number, and MAC address.

However, a device installed on each client apparatus may be removed due to replacement. In this case, the central management apparatus does not delete the registration of the removed device for several months because of the necessity to refer to the history. Therefore, in a case where synchronizing a registration device of the monitoring apparatus with a registration device of the central management apparatus is necessary, the communication may be uselessly performed for a device that does not require the monitoring due to removal or replacement.

The above-mentioned communication is not only useless but also becomes possible to induce a processing delay by increased processing load and timeout due to an increased network load. In particular, if the scale of replacement is large, a greater number of devices will be removed. Accordingly, the processing load will significantly increase due to the above-mentioned useless monitoring processing. The monitoring by the monitoring apparatus will be delayed when the processing delay is caused by the disabled processing.

As a possible method for stopping the above-mentioned useless monitoring processing, it may be useful to enable a user to input device information (e.g., ON/OFF of monitoring flag, or date and time of removal) so that the monitoring apparatus can determine whether to stop the monitoring processing based on the input value. However, according to the above-mentioned method, each user is required to perform a manual input operation. Therefore, obtainable effects will be insufficient. Further, as discussed in Japanese Patent No. 4973516, it is proposed to cancel the registration of a device when the communication of the device is permanently disabled.

However, according to the technique discussed in Japanese Patent No. 4973516, the registration of each removed device is deleted from the central management apparatus. Therefore, it becomes unfeasible to refer to the device information or history about the removed device at a later time.

Further, in a case where each monitoring apparatus performs monitoring processing for a target device on condition that the device is already registered by the central management apparatus, the communication will be disabled if a registration error occurs in the central management apparatus. In such a case, it is desired that a client or a service engineer can change the settings appropriately. However, such a technique is not applicable because the above-mentioned case is not taken into consideration.

### SUMMARY OF THE INVENTION

The present invention intends to solve the above-mentioned problem.

For example, the present invention is directed to a system that enables a monitoring apparatus to stop monitoring a monitoring-free device while causes a management apparatus to hold the registration of the monitoring-free device, whereby it can be possible to realize an effect of reducing communication load and processing load in the monitoring apparatus and an effect of reducing processing delay that may be induced by the communication load/processing load. Further, the present invention is directed to a mechanism capable of flexibly solving the problem (e.g., registration error of a network device) having occurred in the central management apparatus.

According to an aspect of the present invention, a monitoring apparatus includes an acquisition unit configured to acquire a list including a plurality of network devices to be a monitoring target from a management apparatus that manages registration information about a plurality of network devices to be a management target, a monitoring unit configured to acquire device information from the plurality of network devices included in the list and perform monitoring processing, a first transmission unit configured to transmit at least a part of the device information acquired for the monitoring processing to the management apparatus, a generation unit configured to generate, in a case where a network device satisfying a predetermined condition is identified according to a result of the monitoring processing, failure information as failure of the identified network device, a second transmission unit configured to transmit the failure information generated by the generation unit to the management apparatus, and a stop unit configured to stop the monitoring processing for the network device corresponding to the generated failure information based on the predetermined condition.

Further features of the present invention will become apparent from the following description of exemplary embodiments with reference to the attached drawings.

### BRIEF DESCRIPTION OF THE DRAWINGS

FIG. 1 illustrates a schematic configuration of a device management system according to the present exemplary embodiment.

FIG. 2 illustrates a hardware configuration applicable to a central management apparatus, a monitoring apparatus, and a proxy server.

FIG. 3 illustrates a hardware configuration of an image forming apparatus.

FIG. 4 illustrates a software configuration of the monitoring apparatus.

FIG. 5 illustrates a software configuration of the image forming apparatus.

FIG. 6 illustrates a software configuration of the central management apparatus.

FIG. 7 illustrates a diagram including the flowcharts of FIGS. 7A and 7B. FIGS. 7A and 7B are flowcharts illustrating an operation that is performed by the monitoring apparatus.

FIG. 8 is a flowchart illustrating device information update processing that is performed by the monitoring apparatus.

FIG. 9 illustrates an example of a device list that is held by the monitoring apparatus.

FIG. 10 illustrates a monitoring stop condition list that is held by the monitoring apparatus.

FIG. 11 illustrates an example of a monitoring target device list screen.

FIG. 12 illustrates an example of a device information editing screen.

FIG. 13 is a flowchart illustrating an example of UI processing that is performed by the monitoring apparatus.

### DESCRIPTION OF THE EMBODIMENTS

Exemplary embodiments of the present invention will be described in detail below with reference to attached drawings.

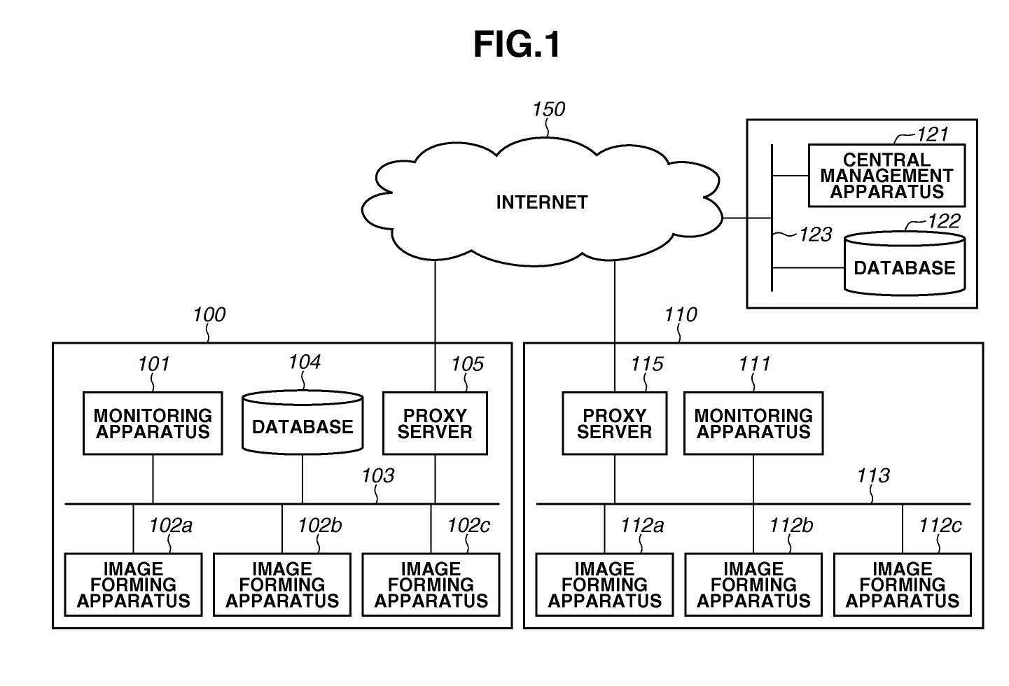

FIG. 1 is a block diagram illustrating a schematic configuration of a device management system according to an exemplary embodiment of the present invention.

As illustrated in FIG. 1, the device management system according to the present exemplary embodiment includes a plurality of client systems, including client systems 100 and 110, which are connected to a central management apparatus 121. The number of the client systems connected to the central management apparatus 121 is not limited to only two. For example, three or more client systems can be connected to the central management apparatus 121. Alternatively, only one client system can be connected to the central management apparatus 121. Although not illustrated in the drawing, an ordinary sales company system is also connected to the device management system.

Information acquired from each of the client systems 100 and 110 is transmitted to the central management apparatus 121 and a database 122 stores the acquired information. The database 122 serves as a history storage unit configured to store various kinds of information, including monitoring-related information and information collected from each client, such as counter information, failure history information, and failure pattern table information about each image forming apparatus.

The central management apparatus 121 and the database 122 are connected via a local area network (LAN) 123. The LAN 123 is connectable to an internet 150. Alternatively, the database 122 may be physically included in the central management apparatus 121. As long as the database 122 is accessible from the central management apparatus 121, the database 122 may be located at another place that is connected to the central management apparatus 121 via the internet 150.

The central management apparatus 121 includes a functional for collecting, storing, and processing information about image forming apparatuses (102 and 112) as monitoring targets and operating state information (including failure information), from monitoring apparatuses 101 and 111, and for giving a warning to an external device. Further, the central management apparatus 121 has a function of distributing the above-mentioned information, for example, to a system of a sales company.

For example, the operating state of the image forming apparatus includes running out of toner, a door opened state, replacement of drum, absence of cartridge, an abnormality of cooling fan, an abnormality of substrate, uncleanness of document positioning glass plate, running out of staple, and light quantity insufficiency of paper feeder sensor. Further, the operating state of the image forming apparatus includes an overflow of font memory, an error in rendering processing, an abnormality of fixing device, an abnormality of counter, an abnormality of two-sided printing unit, and a paper jam. The counter information includes information about a billing counter of a monetary charge target of a sales company, a division counter for each division of a client, a size counter of each paper size, and a parts counter indicating a consumption degree of a component provided in the image forming apparatus.

Further, information about a management target image forming apparatus (i.e., an image forming apparatus to be managed by the central management apparatus 121) and monitoring-related settings can be registered to the central management apparatus 121. The central management apparatus 121 can manage the registered information. The central management apparatus 121 can merge and manage the registered management target image forming apparatuses and monitoring-related settings in a collective manner. Further, the central management apparatus 121 can perform monitoring-related settings for the monitoring apparatuses 101 and 111. The central management apparatus 121 provides a list of monitoring target devices to be monitored by the monitoring apparatus with reference to registration information about each management target device in accordance with a request from the monitoring apparatus.

The device management system according to the present exemplary embodiment provides a service, for example, based on a maintenance contract agreed between a sales company and a client. Accordingly, only an image forming apparatus determined by the sales company as a monitoring target based on the contract is set as a monitoring target of the device management system.

The device management system illustrated in FIG. 1 includes only one central management apparatus 121 and only one database 122. However, an actual device management system may include a plurality of central management apparatuses and a plurality of databases to realize decentralized processing for collecting information from a large number of image forming apparatuses and monitoring apparatuses or for sharing the load in firmware distribution.

A system configuration of a client will be described in detail below.

There is a plurality of client environments different from each other. The example illustrated in FIG. 1 includes two client systems 100 and 110.

The client systems 100 and 110 are clients that are mutually different in configuration. Although the client system 100 includes only three monitoring target devices, the monitoring apparatus 101 can monitor several hundreds or thousands of devices in a large-scale environment.

The client system 110 is configured to perform a remote operation for monitoring a relatively smaller number (e.g., several tens) of devices. The client system 110 has a system configuration that does not include any database. Instead, the monitoring apparatus 111 stores monitoring data in a built-in storage device provided therein. It is assumed that each of the monitoring apparatuses 101 and 111 is, for example, a general personal computer (PC) on which a device management program is installed. There is no substantial difference between two client systems 100 and 110. Although only the client system 100 is described in detail below, the client system 110 is similar to client system 100.

In the client system 100, the monitoring apparatus 101 monitors image forming apparatuses 102a, 102b, and 102c connected to a LAN 103, which is connected to the internet 150. The monitoring apparatus 101 communicates with the central management apparatus 121 via a proxy server 105 and the internet 150.

Hypertext Transfer Protocol (HTTP), Hypertext Transfer Protocol Secure (HTTPS), or Simple Object Access Protocol (SOAP) is usable in communications between the monitoring apparatus 101, the central management apparatus 121, and the image forming apparatuses 102. SOAP is the protocol based on Extended Markup Language (XML) and is used when a user of a computer calls data or a service of other computer. According to the present exemplary embodiment, SOAP is installed on HTTP(S). Through SOAP based communications, it is feasible to transmit and receive SOAP messages each including an XML document together with attached information. Accordingly, a computer having the capability of supporting SOAP is generally equipped with a SOAP message generation unit configured to generate a SOAP message and a SOAP message interpretation unit configured to interpret a SOAP message. In the present exemplary embodiment, the SOAP message is used to transmit the state information of each image forming apparatus to the central management apparatus 121. Further, instead of using the SOAP message, other IF/protocol (e.g., for (Representational State Transfer) REST) can be similarly used in the present exemplary embodiment.

The monitoring apparatus 101 stores information collected from the image forming apparatuses 102a, 102b, and 102c and collection data processing results in a database 104. Further, the monitoring apparatus 101 stores monitoring-related settings for respective image forming apparatuses in the database 104 or in a built-in storage device of the monitoring apparatus 101. When the monitoring apparatus 101 receives state information (e.g., occurrence of failure) from the image forming apparatuses 102a, 102b, and 102c, the monitoring apparatus 101 stores the received state information in the database 104 and transmits the state information to the central management apparatus 121.

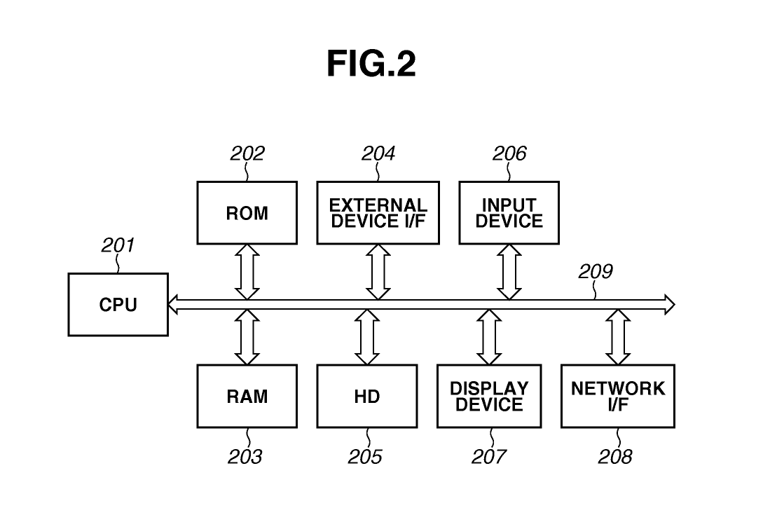

FIG. 2 is a block diagram illustrating a hardware configuration of an information processing apparatus, which is applicable to the central management apparatus 121, the monitoring apparatuses 101 and 111, and the proxy servers 105 and 115. Further, the illustrated configuration is applicable to an information processing apparatus installed on a back-end (not illustrated).

The information processing apparatus illustrated in FIG. 2 includes a central processing unit (CPU) 201. The CPU 201 is a control unit configured to execute an application program, a printer driver program, an operating system (OS), and a device management program according to the present invention, which are stored in a hard disk (HD) 205. Although the above-mentioned configuration example includes only one CPU, it is feasible to provide a plurality of CPUs.

A read only memory (ROM) 202 is a non-rewritable storage unit, which stores a basic I/O program, a control program that realizes various kinds of processing to be performed by the information processing apparatus, and related data. A random access memory (RAM) 203 can temporarily store information required to execute each program and related files. The RAM 203 is functionally operates as a main memory or a work area for the CPU 201. To realize the processing of the monitoring apparatuses 101 and 111 for each step illustrated in each flowchart described below, the CPU 201 performs processing based on program codes stored in the storage devices 202 and 205 or in a storage medium described below.

An external device I/F 204 is connectable to various external devices. When a storage device (e.g., a hard disk drive) or a reader apparatus dedicated to a storage medium is connected to the external device I/F 204, a program stored in the storage device or the storage medium can be loaded into the information processing apparatus. The storage medium is, for example, a flexible disk (FD), a compact disk read only memory (CD-ROM), a compact disk readable (CD-R), a compact disk rewritable (CD-RW), a PC card, a digital versatile disk (DVD), an IC memory card, a magneto-optical drive (MO), or a memory stick.

The hard disk (HD) 205 stores various data, including programs and data relating to respective processing to be performed by the apparatus, temporary data, information relating to each monitoring target image forming apparatus according to the present invention, and data collected from each image forming apparatus. Although the above-mentioned configuration example includes only one HD, it is feasible to provide a plurality of HDs. Further, the information processing apparatus can be configured to include a solid state drive (SSD).

An input device 206, serving as an instruction input unit, includes a keyboard and a pointing device. The input device 206 enables a user of the system, such as a service engineer, an operator, or an administrator, to perform settings for the information processing apparatus and input operational instructions.

A display device 207, serving as a display unit, displays an instruction input via the input device 206 and displays operational states and settings of the management target image forming apparatus. In actual, it will be a possibility that a drawing command issued by an application via the mechanism of the OS is interpreted by a graphic card and information converted into an analog signal or a digital signal is displayed on the display device 207. In the present exemplary embodiment, a display control includes processing for issuing a drawing command via the OS to cause the display unit (e.g., the display device 207) to display information.

A network interface (Network I/F) 208 connects to the LAN and the internet via the network and performs information exchange processing with an external device. The information processing apparatus transmits and receives data to and from the external apparatus via the network interface 208. A system bus 209 connects the above-mentioned elements (201 to 208) provided in the information processing apparatus to transmit and receive data.

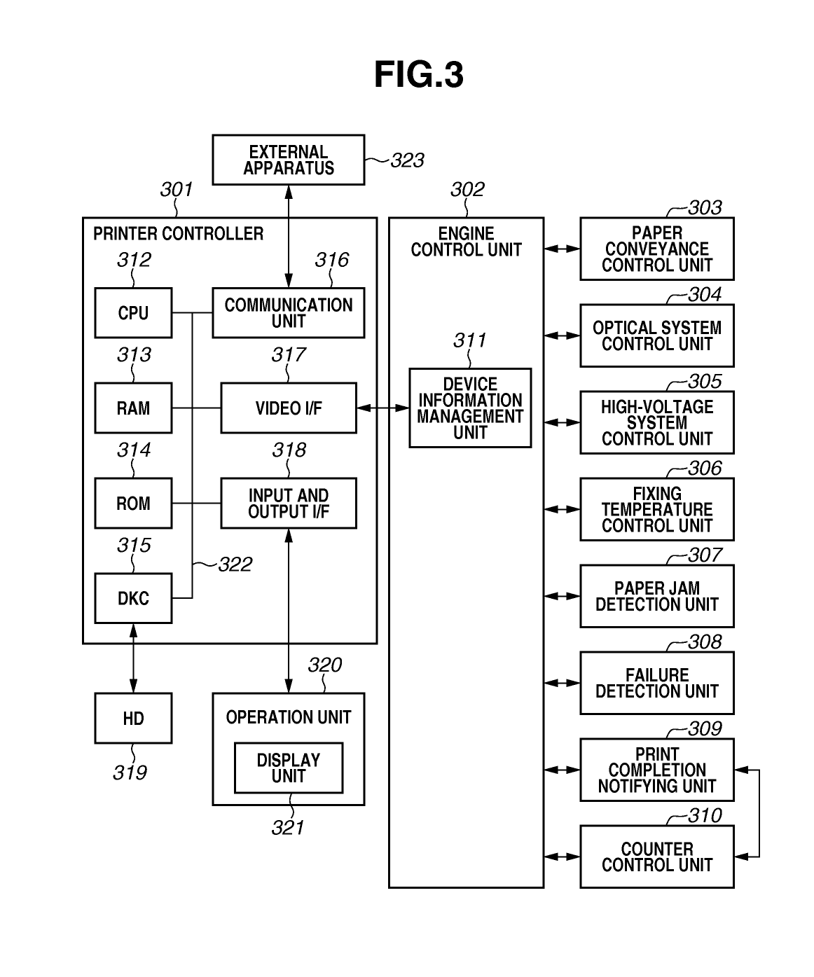

FIG. 3 is a block diagram illustrating a hardware configuration of a printer control unit and a peripheral portion thereof, which are provided in the image forming apparatuses 102 and 112.

The hardware configuration illustrated in FIG. 3 includes a printer controller 301.

The printer controller 301 includes a communication unit 316 that can communicate with an external apparatus 323, such as a host computer (e.g., the monitoring apparatuses 101 and 111 illustrated FIG. 1), to perform various data transmission/reception processing according to predetermined protocols. The printer controller 301 includes a video I/F 317 provided for communications and reception of image data. The video I/F 317 rasterizes the received image data into printable information and performs signal transmission/reception or serial communication processing with an engine control unit 302.

A CPU 312 of the image forming apparatus can control accesses to various devices connected to a system bus 322 based on a control program stored in a ROM 314 or a hard disk (i.e., an external memory) 319. Further, the CPU 312 can output an image signal, as output information, to a printer engine connected via the video I/F 317.

A RAM 313 functionally operates as a main memory or a work area for the CPU 312. A disk controller (DKC) 315 controls accesses to the external memory 319, such as the hard disk, which stores a boot program, various applications, font data, user files, and setting files. The information processing apparatus can be configured to include a solid state drive (SSD) as the external memory.

An operation unit 320 includes a display unit 321 and an input unit (e.g., a keyboard). The operation unit 320 enables an operator to view or check information provided via an input and output I/F 318. Further, the operation unit 320 enables an operator to input instructions.

The engine control unit 302 transmits and receives signals to and from the printer controller 301. The engine control unit 302 controls each unit of the printer engine via serial communications. A paper conveyance control unit 303 performs printing paper conveyance processing, including discharge of a printed paper, based on an instruction from the engine control unit 302. An optical system control unit 304 performs a scanner motor driving control and a laser ON/OFF control based on instructions from the engine control unit 302.

A high-voltage system control unit 305 performs a high-voltage output control required for electrophotographic processes, including charging, development, and transfer, based on instructions from the engine control unit 302. A fixing temperature control unit 306 performs a fixing device temperature control based on an instruction from the engine control unit 302 and detects, for example, abnormality of the fixing device.

A paper jam detection unit 307 detects a conveyance defectiveness that may occur when a paper is conveyed. A failure detection unit 308 detects a failure of each functional unit provided in the printer. A print completion notifying unit 309 detects that a printing operation is normally performed and notifies the engine control unit 302 and a counter control unit 310 of a detection result. The counter control unit 310 holds counting information of various counters, such as the billing counter and the parts counter, and updates the counting information of various counters when the print processing completes.

The engine control unit 302 includes a device information management unit 311 that manages information about each unit of the printer engine. For example, the device information management unit 311 acquires counter information of various counters from the counter control unit 310 according to a request from the external apparatus 323 and sends the acquired counter information to the video I/F 317. Thus, the counter information is transmitted to the external apparatus 323 via the video I/F 317 and the communication unit 316. Further, in a case where an information acquisition request is received from the external apparatus 323, the device information management unit 311 acquires information appropriately from each unit.

Further, the device information management unit 311 manages paper jam information notified from the paper jam detection unit 307 and alarm or error information notified from the failure detection unit 309. In a case where an event notification request is received beforehand from the external apparatus 323, the device information management unit 311 transmits the alarm or error information to the external apparatus 323 via the video I/F 317 of the printer controller 301.

The image forming apparatus according to the present invention can be realized as a laser beam printer that performs a printing operation according to the above-mentioned electrophotographic method, an inkjet printer that performs a printing operation according to an inkjet method, a thermal head printer that performs a printing operation according to a thermal transfer method, a copying machine, or the like.

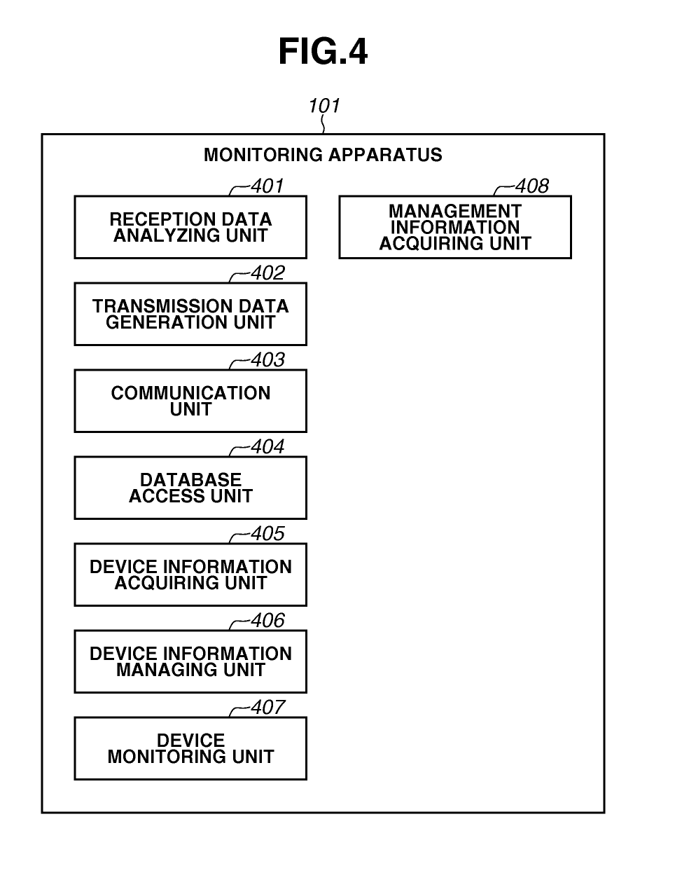

FIG. 4 is a block diagram illustrating a software configuration applicable to the monitoring apparatuses 101 and 111. Each unit illustrated in FIG. 4 can be installed as a software program. To realize each unit, the CPU 201 of the monitoring apparatuses 101 and 111 reads a related program from the HD 205 or the like and executes the program.

A reception data analyzing unit 401 analyzes reception data received from the central management apparatus 121 and the image forming apparatuses 102 and 112 via a communication unit 403 and transmits the reception data to an appropriate processing unit for each data.

A transmission data generation unit 402 can generate transmission data that complies with communication protocols in response to a request from each processing unit. The generated transmission data is transmitted to the central management apparatus 121 and the image forming apparatuses 102 and 112 via the communication unit 403.

The communication unit 403 transmits/receives data to/from an external information processing apparatus, such as the central management apparatus 121 and the image forming apparatuses 102 and 112, via the network (e.g., the LAN and the Internet).

A database access unit 404 controls input/output processing for the database 104. Further, the database access unit 404 controls input/output processing for a built-in storage device in a case where the storage device stores necessary data (e.g., monitoring data and setting data).

A device information acquiring unit 405 acquires various types of device information, including operational states of the image forming apparatuses 102 and 112 and capability information about each image forming apparatus.

A device information managing unit 406 manages device information, which corresponds to a monitoring target image forming apparatus registered in the central management apparatus 121, acquired from the device information acquisition unit 405. The device information management unit 406 stores various types of information in the database 104 via the database access unit 404.

A device monitoring unit 407 performs processing for monitoring each monitoring target device. The device monitoring unit 407 causes the device information acquisition unit 405 to collect monitoring information according to a transmission schedule instructed by the central management apparatus 121. The device information management unit 406 manages the collected monitoring information. The transmission data generation unit 402 processes the collected monitoring information into transmission data according to the transmission schedule. The communication unit 403 transmits at least a part of the collected monitoring information to the central management apparatus 121. Further, the device monitoring unit 407 processes device event data, including addition of monitoring device, a paper jam, and run out of toner. In response to the occurrence of a specific error (e.g., detection of a device event or inconsistency in device serial number), the device monitoring unit 407 causes the transmission data generation unit 402 to generate a pseudo-alarm and causes the communication unit 403 to transmit the generated pseudo-alarm to the central management apparatus 121.

A management information acquiring unit 408 acquires management information (e.g., regular transmission schedule for own apparatus and related instruction) from the central management apparatus 121. The management information acquisition unit 408 causes the transmission data generation unit 402 to generate a request to acquire a list of monitoring target devices to be monitored by the own apparatus. The management information acquisition unit 408 causes the communication unit 403 to transmit the generated request to the central management apparatus 121. The management information acquisition unit 408 then acquires a monitoring target device list transmitted from the central management apparatus 121. In the present exemplary embodiment, acquisition of the monitoring target device list is performed in response to an instruction from the device monitoring unit 407 as mentioned above. However, the management information acquisition unit 408 may be configured to perform the above-mentioned operation solely.

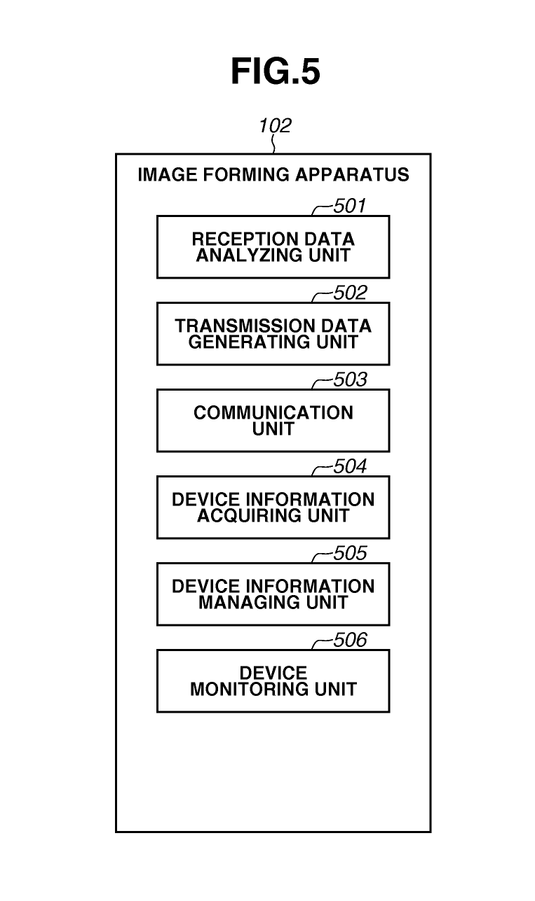

FIG. 5 is a block diagram illustrating a software configuration applicable to the image forming apparatuses 102 and 112. Each unit illustrated in FIG. 5 can be installed as a software program. To realize each unit, the CPU 312 of each of the image forming apparatuses 102 and 112 reads a related program from the ROM 314 or the HD 319 and executes the program.

A reception data analyzing unit 501 analyzes reception data received via a communication unit 503 from the central management apparatus 121 and the monitoring apparatuses 101 and 111 and transmits the reception data to an appropriate processing unit for each data.

A transmission data generating unit 502 generates transmission data that complies with communication protocols in response to a request from each processing unit. The generated transmission data is transmitted to the central management apparatus 121 and the monitoring apparatuses 101 and 111 via the communication unit 503.

The communication unit 503 transmits/receives data to/from an external apparatus, such as the central management apparatus 121 and the monitoring apparatuses 101 and 111, via the network (e.g., the LAN and the Internet).

A device information acquiring unit 504 acquires state information, such as a service call or a paper jam having occurred in the image forming apparatus. Further, the device information acquiring unit 504 acquires various types of information, such as counter information held by the image forming apparatus, in response to instructions from the monitoring apparatuses 101 and 111. The transmission data generating unit 502 processes the data acquired by the device information acquiring unit 504 into transmission data. The communication unit 503 can transmit the processed transmission data to an acquisition request source (e.g., the monitoring apparatus 101 or 111). A device information managing unit 505 manages and controls the device information collected by the device information acquiring unit 504.

A device monitoring unit 506 monitors the own device when a monitoring function of the device is validated, similar to the external monitoring apparatus. The device monitoring unit 506 causes the device information acquiring unit 504 to collect monitoring information according to the transmission schedule instructed by the central management apparatus 121 or an instruction from an external application. The device information management unit 505 manages the monitoring information. The monitoring information is processed into transmission data according to the transmission schedule or the external instruction, and the communication unit 503 transmits the transmission data to the central management apparatus 121. Further, similar to the external monitoring apparatus, the device monitoring unit 506 processes event data of each device and appropriately transmits the processed event data to the central management apparatus 121 or to the monitoring apparatus 101 or 111.

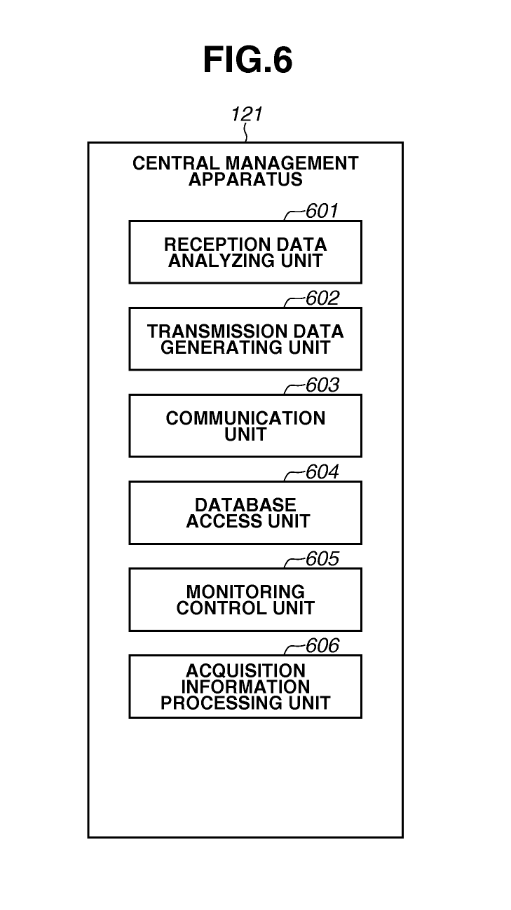

FIG. 6 is a block diagram illustrating an example of a software configuration of the central management apparatus 121. Each unit illustrated in FIG. 6 is installed as a software program. To realize each unit, the CPU 201 of the central management apparatus 121 reads a related program from the HD 205 and executes the program.

A reception data analyzing unit 601 analyzes reception data received via a communication unit 603 from the monitoring apparatuses 101 and 111 and the image forming apparatuses 102 and 112 and transmits the reception data to an appropriate processing unit for each data.

A transmission data generating unit 602 generates transmission data that complies with communication protocols in response to a request from each processing unit. The generated transmission data is transmitted to the monitoring apparatuses 101 and 111 and the image forming apparatuses 102 and 112 via the communication unit 603.

The communication unit 603 transmits/receives data to/from an external information processing apparatus, such as the monitoring apparatuses 101 and 111 and the image forming apparatuses 102 and 112, via the network (e.g., the LAN and the Internet).

A database access unit 604 controls input/output processing for the database 122.

A monitoring control unit 605 manages a schedule for acquiring monitoring information and monetary charge information from all monitoring apparatuses and controls monitoring contents and a method thereof. Further, if necessary, the monitoring control unit 605 transmits instructions and responses, via the transmission data generating unit 602 and the communication unit 603, to the monitoring apparatuses 101 and 111 (i.e., management target devices).

An acquisition information processing unit 606 directly stores information received from the monitoring apparatuses 101 and 111 (i.e., the management target devices), or stores processed information thereof, in the database 122 via the database access unit 604. Further, the acquisition information processing unit 606 notifies a service engineer or a client of summary of the counter information the error information (including the pseudo-alarm), and the like based on the information received from the monitoring apparatuses 101 and 111 and the stored data in the database 122.

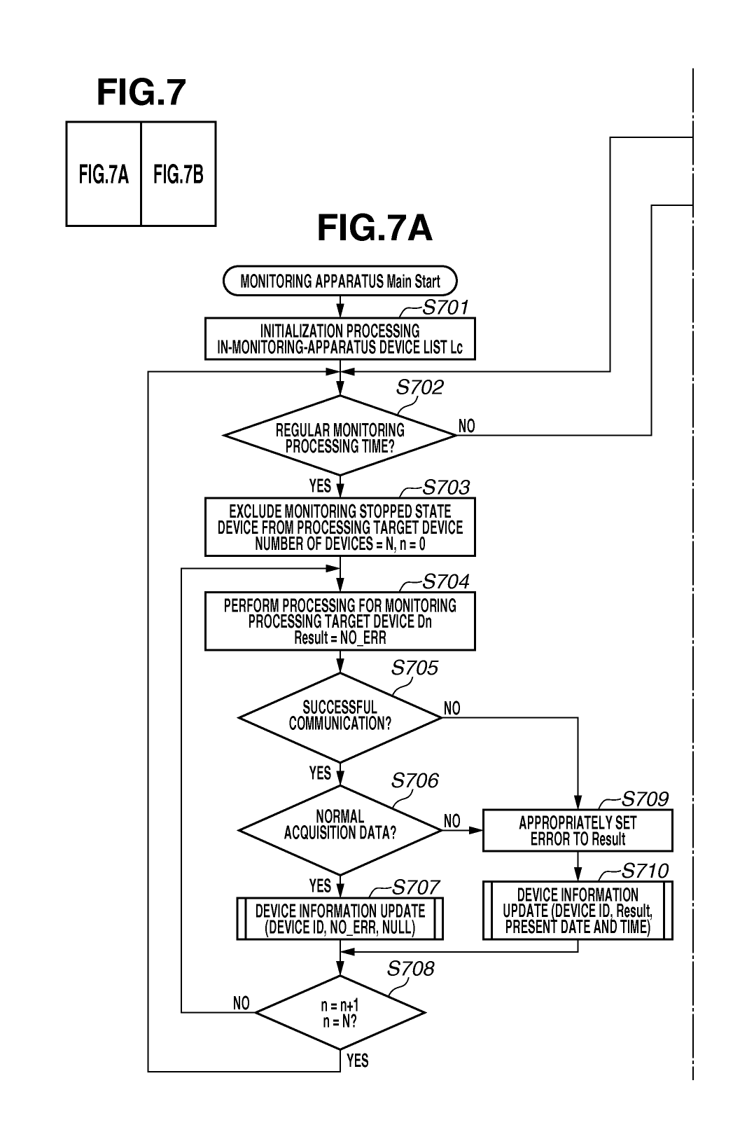

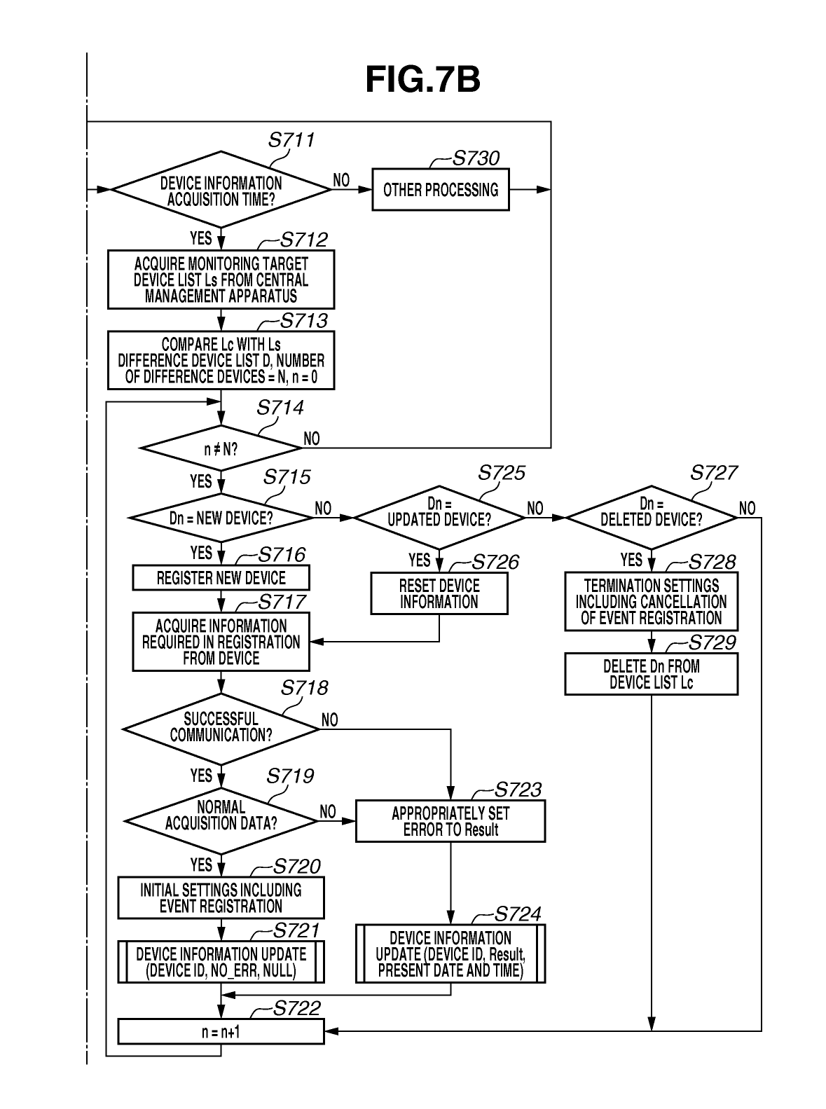

FIG. 7 illustrates a diagram including the flowcharts of FIGS. 7A and 7B. FIGS. 7A and 7B are flowcharts illustrating main processing that is performed by the monitoring apparatuses 101 and 111. To simplify the description, an operation that is performed by the monitoring apparatus 101 of the client system 100 will be described below. However, the monitoring apparatus 111 of the client system 110 can perform a similar operation. Further, only the processing relating to the present invention will be described in detail below with reference to the flowchart illustrated in FIG. 7, to avoid redundant description of other processing not relevant to the present invention. In the following description, each monitoring target image forming apparatus may be referred to as a monitoring target device or may be simply referred to as a device. Further, in the present exemplary embodiment, the device monitoring unit 407 mainly performs the processing described below.

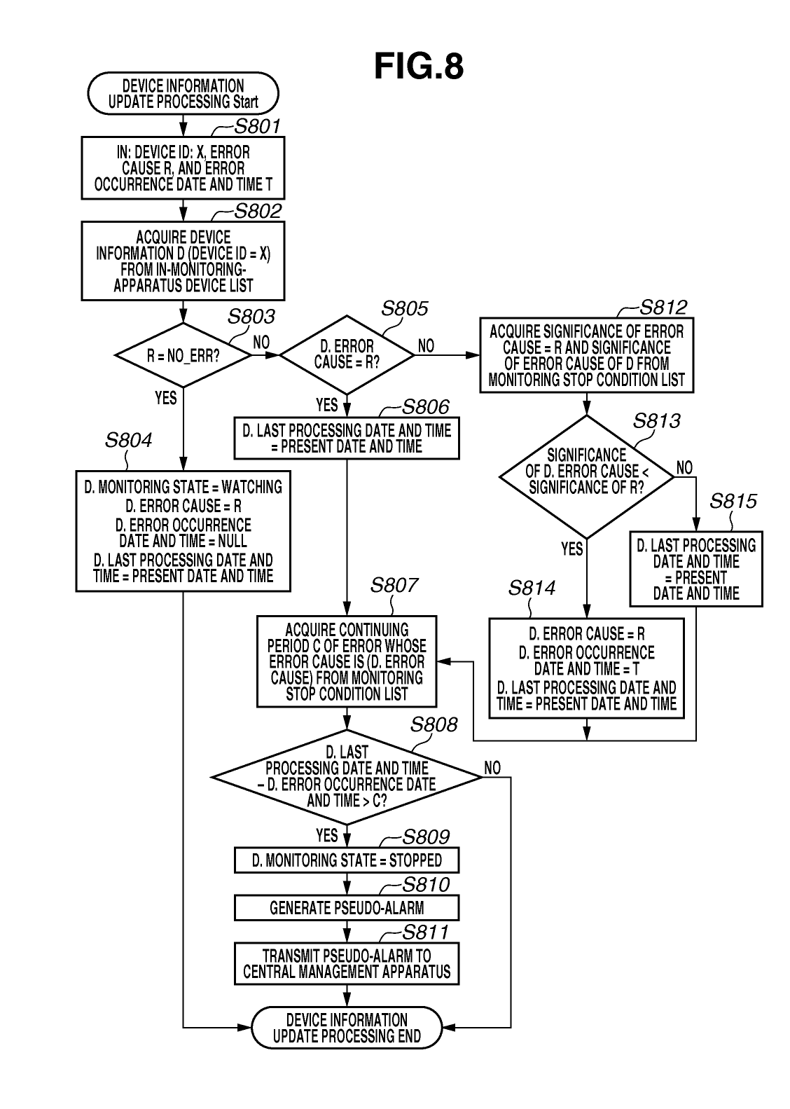

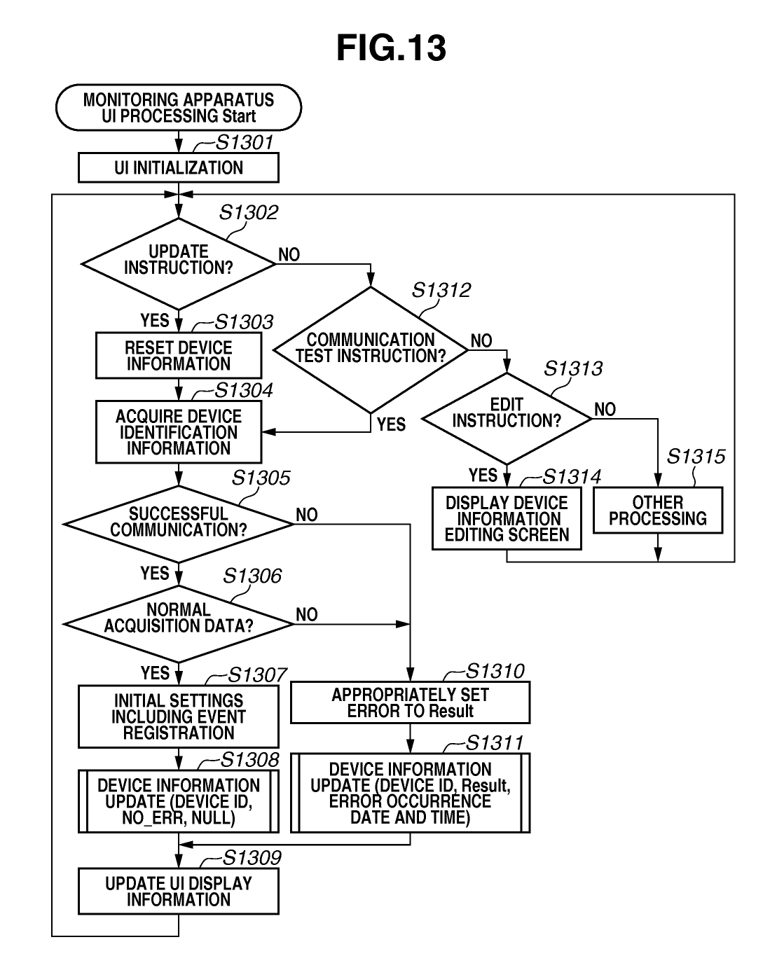

To realize processing of each step in flowcharts illustrated in FIGS. 7, 8, and 13 (flowcharts illustrated in FIGS. 8 and 13 are described below), in the present exemplary embodiment, the CPU 201 provided in the monitoring apparatus 111 (or the monitoring apparatus 101) reads a control program according to the present invention from a nonvolatile storage device (e.g., the ROM 202 or the HD 205) and executes the control program.

First, in step S701, the monitoring apparatus 111 performs system initialization in response to a turn-on of a power source. More specifically, the monitoring apparatus 111 reads initial setting information and performs initialization processing for each operation unit. For example, the device information management unit 406 performs processing for reading an in-monitoring-apparatus device list Lc into the RAM 203 or the HD 205, via the database access unit 404. The in-monitoring-apparatus device list Lc is a table of information about all monitoring target image forming apparatuses stored in the monitoring apparatus 101. The device monitoring unit 407 performs device monitoring related initialization processing for the in-monitoring-apparatus device list Lc. For example, the device monitoring unit 407 performs event registration for each device.

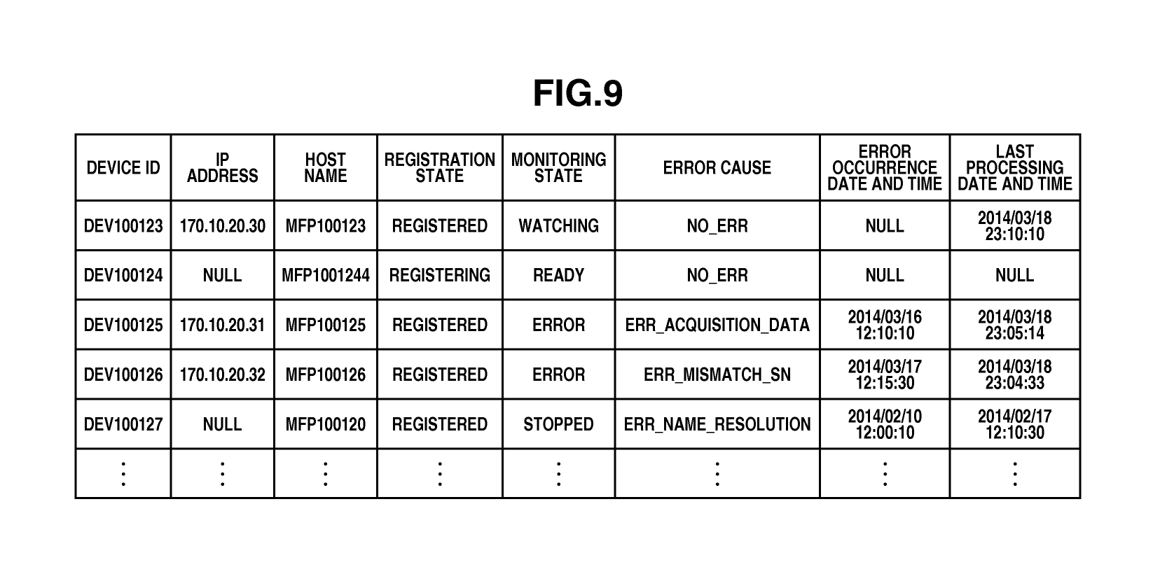

FIG. 9 illustrates an example of the in-monitoring-apparatus device list Lc.

As illustrated in FIG. 9, the in-monitoring-apparatus device list Lc includes a plurality of items of device ID, IP address, host name, registration state, monitoring state, error cause, error occurrence date and time, and last processing date and time.

The item “device ID” is identification information (ID) that can uniquely identify each device. The items “IP address” and “host name” are referred to in identifying the address of each device. Usually, designating one of IP address and host name derives the other based on name resolution.

The item “registration state” represents the state of registration processing described below. The monitoring apparatus acquires capability information before starting a device monitoring operation, in addition to device unique information (e.g., product name, serial number, and MAC address of each device). Therefore, the monitoring apparatus performs the monitoring operation according to the capability of each device. The above-mentioned sequential work is referred to as device registration processing in the present exemplary embodiment. The “registration state” in the device list represents the state of the registration processing. Registration states include registration in progress (REGISTERING) and registration completed (REGISTERED).

The item “monitoring state” represents the state of trial communication with the device partially performed in monitoring processing. Monitoring states includes monitoring in progress (WATCHING), monitoring preparation in progress (READY), error (ERROR), and monitoring stop (STOPPED).

The item “error cause” represents the cause of each error that has resulted in ERROR or STOPPED in the monitoring state. If the error cause is NO_ERR, it means that no error has occurred.

The item “error occurrence date and time” represents the date and time of the occurrence of each error.

The item “last processing date and time” represents the date and time of the latest communication performed with the device.

The rest of the flowchart illustrated in FIG. 7 will be described.

After the above-mentioned initialization processing in step S701 has been completed, the device monitoring unit 407 starts ordinary processing. In step S702, the device monitoring unit 407 determines whether regular monitoring processing time has come. In a case where the device monitoring unit 407 determines that the regular monitoring processing time has come (YES in step S702), the operation proceeds to step S703.

In step S703, the device monitoring unit 407 refers to the device information about processing target devices in each regular monitoring processing, included in the in-monitoring-apparatus device list Lc, and excludes each device whose monitoring state is “monitoring stop (STOPPED).” Further, the device monitoring unit 407 initializes a processing variable N to the number of processing target devices and a processing variable n to “0.” Then, the operation proceeds to step S704.

In step S704, the device monitoring unit 407 initializes a processing variable Result to “NO_ERR (no error)” and sets an n-th element of the processing target device to Dn (n:0 to N−1). The device monitoring unit 407 communicates with the processing target device Dn and performs processing for monitoring the processing target device Dn. The above-mentioned monitoring processing includes collection of monetary charge data and acquisition of various counter values, which are not relevant to the present invention and therefore redundant description thereof will be avoided.

In step S705, the device monitoring unit 407 determines whether the communication in the above-mentioned monitoring processing performed in step S704 has been successfully completed.

In a case where the device monitoring unit 407 determines that the communication in the monitoring processing has been successfully completed (YES in step S705), the operation proceeds to step S706.

In step S706, the device monitoring unit 407 determines whether the acquisition data acquired in the above-mentioned monitoring processing in step S704 is normal (i.e., a value expected).

In a case where the device monitoring unit 407 determines that the acquisition data is normal (YES in step S706), the operation proceeds to step S707.

In step S707, the device monitoring unit 407 performs device information update processing using the device ID of the processing target device Dn, Result=NO_ERR, and error occurrence date and time=NULL, as input parameters. In the present exemplary embodiment, the device information management unit 406 mainly performs the device information update processing in response to a request from the device monitoring unit 407. The device information update processing will be described in detail below with reference to the flowchart illustrated in FIG. 8.

In the above-mentioned step S705, in a case where the device monitoring unit 407 determines that the communication in the monitoring processing has been failed (namely, when the communication result is error) (NO in step S705), the operation proceeds to step S709.

Further, in the above-mentioned step S706, in a case where the device monitoring unit 407 determines that the acquisition data is not normal (namely, when the acquisition result is error) (NO in step S706), the operation proceeds to step S709.

In step S709, the device monitoring unit 407 appropriately sets an error value corresponding to the above-mentioned error determined in step S705 or S706 (i.e., the error cause in the case where the communication result in the monitoring processing or the acquisition result is error) to Result. The above-mentioned error determined in step S705 is an error in communication, such as “name resolution is unfeasible” (i.e., ERR_NAME_RESOLUTION according to the present exemplary embodiment) or “timeout of communication” (e.g., ERR_TIMEOUT according to the present exemplary embodiment). Further, the above-mentioned error determined in step S706 is an error in a case where the acquisition data is different from the expected value although the communication has been successfully completed. For example, the error determined in step S706 is inconsistency in serial number (i.e., ERR_MISMATCH_SN according to the present exemplary embodiment). The device monitoring unit 407 sets the above-mentioned error values to Result.

Once the above-mentioned processing in step S709 completes, then in step S710, the device monitoring unit 407 performs the device information update processing (see FIG. 8) using the device ID of the processing target device Dn, the above-mentioned Result value having been set in step S709, and error occurrence date and time=present date and time, as input parameters.

After the above-mentioned device information update processing in step S707 or S710 completes, in step S708, the device monitoring unit 407 increments the processing variable n by 1, and determines whether the processing variable n is equal to N. More specifically, the device monitoring unit 407 determines whether the above-mentioned processing has been completed for all monitoring target devices.

In a case where the device monitoring unit 407 determines that the processing variable n is not equal to N, namely when the above-mentioned processing is not yet completed for all monitoring target devices (NO in step S708), the operation returns to step S704 to perform the above-mentioned processing for the next monitoring target device.

On the other hand, in a case where the device monitoring unit 407 determines that the processing variable n is equal to N, namely when the above-mentioned processing has been completed for all monitoring target devices (YES in step S708), the operation returns to step S702 to perform the determination processing relating to the regular monitoring processing time.

Further, in the above-mentioned step S702, in a case where the device monitoring unit 407 determines that the regular monitoring processing time has not come yet (NO in step S702), the operation proceeds to step S711.

In step S711, the device monitoring unit 407 determines whether the time to acquire the device information from the central management apparatus 121 has come.

In a case where it is determined that the time to acquire the device information from the central management apparatus 121 has not come yet (NO in step S711), then in step S730, the device monitoring unit 407 appropriately performs other processing. For example, when the time to transmit the information acquired by the monitoring processing to the central management apparatus 121 has come, the device monitoring unit 407 transmits the information acquired by the monitoring processing to the central management apparatus 121. The processing to be performed in step S730 is not relevant to the present invention. Therefore, redundant description thereof will be avoided.

On the other hand, in the above-mentioned step S711, in a case where the device monitoring unit 407 determines that the time to acquire the device information from the central management apparatus 121 has come (YES in step S711), the operation proceeds to step S712. In the present exemplary embodiment, the processing for acquiring the device information from the central management apparatus 121 is regularly performed (e.g., at intervals of several hours). However, the device information acquiring processing is not limited to the above-mentioned example.

In step S712, the device monitoring unit 407 requests the management information acquisition unit 408 to acquire a monitoring target device list Ls from the central management apparatus 121. More specifically, the management information acquisition unit 408 causes the transmission data generation unit 402 to generate a monitoring target device list acquisition request and causes the communication unit 403 to transmit the generated request to the central management apparatus 121. The central management apparatus 121 receives the request via the communication unit 603. The reception data analyzing unit 601 analyzes the received request and detects the monitoring target device list acquisition request. In response to the monitoring target device list acquisition request, the monitoring control unit 605 causes the transmission data generating unit 602 to generate monitoring target device list information about the monitoring apparatus. The communication unit 603 transmits a response including the monitoring target device list information to the monitoring apparatus 101. In the monitoring apparatus 101, the management information acquisition unit 408 receives the above-mentioned response via the communication unit 403 and sends the received response to the device monitoring unit 407. The device monitoring unit 407 acquires the above-mentioned response as the monitoring target device list Ls.

In step S713, the device monitoring unit 407 requests the device information management unit 406 to compare the above-mentioned monitoring target device list Ls acquired in step S712 with the in-monitoring-apparatus device list Lc and acquires a difference device list D as a comparison result. In addition, the device monitoring unit 407 initializes the number of difference devices to N and the processing variable n to “0.” The difference device list D is a temporary list dedicated to the comparison processing, which is held in a memory (e.g., the RAM 203) and is discarded when the present processing has been completed. The difference device list D includes registered devices each being classified into one of three categories (i.e., new/updated/deleted) through the above-mentioned comparison processing. Further, the device information includes, at least, device ID identifying each device and pointer to the entity of each device information. A device is classified into “new device” in a case where it has been registered in the monitoring target device list Ls and is not yet registered in the in-monitoring-apparatus device list Lc. A device is classified into “updated device” in a case where it has communication information (e.g., host name and IP address) or device identification information (e.g., MAC address) having been changed, although the device itself has already been registered in both the monitoring target device list Ls and the in-monitoring-apparatus device list Lc. A device is classified to “deleted device” in a case where it is not registered in the monitoring target device list Ls although it has been registered in the in-monitoring-apparatus device list Lc. The difference device list D includes the device type information registered as information about each device.

After the above-mentioned processing in step S713 is completed, then in step S714, the device monitoring unit 407 determines whether the processing variable n is not equal to N.

Then, in a case where the device monitoring unit 407 determines that the processing variable n is not equal to N (YES in step S714), the operation proceeds to step S715.

In step S715, the device monitoring unit 407 determines whether an n-th element Dn of the difference device list D is the new device.

In a case where the device monitoring unit 407 determines that the n-th element Dn of the difference device list D is the new device (YES in step S715), the operation proceeds to step S716.

In step S716, the device monitoring unit 407 instructs the device information management unit 406 to perform processing required in new device registration (e.g., registration of the element Dn to the in-monitoring-apparatus device list Lc and the database 104).

In step S717, the device monitoring unit 407 acquires information required in the registration processing from the new device. The information to be acquired in this case includes device identification information (e.g., serial No. or MAC address) and capability information.

In step S718, the device monitoring unit 407 determines whether the communication in the above-mentioned acquisition processing performed in step S717 has been successfully completed, similar to the above-mentioned step S705.

Then, in a case where the device monitoring unit 407 determines that the communication in the above-mentioned acquisition processing has been successfully completed (YES in step S718), the operation proceeds to step S719.

In step S719, the device monitoring unit 407 determines whether the acquisition data acquired in the above-mentioned acquisition processing performed in step S717 is normal (i.e., a value expected).

Then, In a case where the device monitoring unit 407 determines that the acquisition data is normal (YES in step S719), the operation proceeds to step S720.

In step S720, the device monitoring unit 407 performs device related initial settings (e.g., event registration for the device and the like). Then, the operation proceeds to step S721.

In step S721, the device monitoring unit 407 performs device information update processing for the new device. More specifically, the device monitoring unit 407 performs the device information update processing using the device ID of the processing target device Dn, Result=NO_ERR, and error occurrence date and time=NULL, as input parameters, similar to the above-mentioned step S707. Then, the operation proceeds to step S722.

Further, in the above-mentioned step S718, in a case where the device monitoring unit 407 determines that the communication in the acquisition processing has been failed (NO in step S718), the operation proceeds to step S723.

Further, in the above-mentioned step S719, in a case where the device monitoring unit 407 determines that the acquisition data is not normal (NO in step S719), the operation proceeds to step S723.

In step S723, the device monitoring unit 407 appropriately sets an error value to Result, similar to the above-mentioned step S709.

In step S724, the device monitoring unit 407 performs the device information update processing using the device ID of the new device, the Result value having been set in step S721, and error occurrence date and time=present date and time, as input parameters. Then, the operation proceeds to step S722.

Further, in the above-mentioned step S715, in a case where the device monitoring unit 407 determines that the n-th element Dn of the difference device list D is not the new device (NO in step S715), the operation proceeds to step S725.

In step S725, the device monitoring unit 407 determines whether the n-th element Dn of the difference device list D is the updated device.

In a case where the device monitoring unit 407 determines that the n-th element Dn of the difference device list D is the updated device (YES in step S725), the operation proceeds to step S726.

In step S726, the device monitoring unit 407 resets the changed information, the monitoring state, the error cause, the error occurrence date and time, and the last processing date and time. According to the present exemplary embodiment, the device monitoring unit 407 resets an error continuing period by setting the monitoring state to READY (monitoring preparation in progress), the error cause to NO_ERR (no error), the error occurrence date and time to NULL, and the last processing date and time to NULL. After the above-mentioned processing in step S726 completes, the operation proceeds to step S717 to update the device information by performing processing similar to that for the new registration. More specifically, in a case where the information acquired from the central management apparatus 121 includes updated information about the device whose monitoring processing has been stopped, the above-mentioned device is not excluded from the processing target devices in the next step S703. Thus, the device monitoring unit 407 restarts the monitoring processing for the above-mentioned device.

Further, in the above-mentioned step S725, in a case where the device monitoring unit 407 determines that the n-th element Dn of the difference device list D is not the updated device (NO in step S725), the operation proceeds to step S727.

In step S727, the device monitoring unit 407 determines whether the n-th element Dn of the difference device list D is the deleted device.

In a case where the device monitoring unit 407 determines that the n-th element Dn of the difference device list D is the deleted device (YES in step S727), the operation proceeds to step S728.

In step S728, the device monitoring unit 407 performs processing required in device registration cancellation (e.g., cancellation of the event registration). Subsequently, in step S729, the device monitoring unit 407 instructs the device information management unit 406 to delete the element Dn from the in-monitoring-apparatus device list Lc and the database 104. Then, the operation proceeds to step S722.

On the other hand, in the above-mentioned step S727, in a case where the device monitoring unit 407 determines that the n-th element Dn of the difference device list D is not the deleted device (NO in step S727), the operation directly proceeds to step S722.

After the above-mentioned processing in steps S721, S724, or S729 completes, or in a case where the determination result in step S727 is NO, then in step S722, the device monitoring unit 407 increments the processing variable n by 1. Then, the operation returns to step S714.

Further, in the above-mentioned step S714, in a case where it is determined that processing variable n is equal to N (NO in step S714), the device monitoring unit 407 determines that there is not any processing target device that is not yet processed. Then, the operation returns to step S702.

The device information update processing to be performed in steps S707, S710, S721, and S724 illustrated in FIG. 7 will be described in detail below with reference to FIG. 8.

FIG. 8 is a flowchart illustrating an example of the device information update processing. The device information management unit 406 mainly performs the device information update processing in response to a request from the device monitoring unit 407.

In step S801, the device information management unit 406 sets the device ID to X, the error cause (Result) to R, and the error occurrence date and time to T, each being an INPUT argument (i.e., an input parameter).

In step S802, the device information management unit 406 acquires device information D whose device ID is X from the device information included in the in-monitoring-apparatus device list Lc.

In step S803, the device information management unit 406 determines whether R is NO_ERR (no error).

Then, in a case where the device information management unit 406 determines that R is NO_ERR (no error) (YES in step S803), the operation proceeds to step S804.

In step S804, the device information management unit 406 sets the monitoring state of the device information D to WATCHING (monitoring in progress), the error cause of the device information D to R, the error occurrence date and time of the device information D to NULL, and the last processing date and time of the device information D to present date and time. Further, the device information management unit 406 updates the in-monitoring-apparatus device list Lc and the database 104 based on the device information D. Then, the device information management unit 406 terminates the device information update processing of the flowchart illustrated in FIG. 8.

On the other hand, in the above-mentioned step S803, in a case where the device information management unit 406 determines that R is not NO_ERR (no error) (NO in step S803), the operation proceeds to step S805.

In step S805, the device information management unit 406 determines whether the error cause of the device information D is equal to R.

Then, in a case where it is determined that the error cause of the device information D is equal to R (YES in step S805), the device information management unit 406 determines that the device information D is error continuing state. Subsequently, the operation proceeds to step S806.

In step S806, the device information management unit 406 updates only the last processing date and time of the device information D based on the present date and time, and updates the in-monitoring-apparatus device list Lc and the database 104 based on the device information D. Then, after the processing of step S806 completes, the operation proceeds to step S807.

On the other hand, in the above-mentioned step S805, in a case where the device information management unit 406 determines that the error cause of the device information D is not equal to R (NO in step S805), the operation proceeds to step S812.

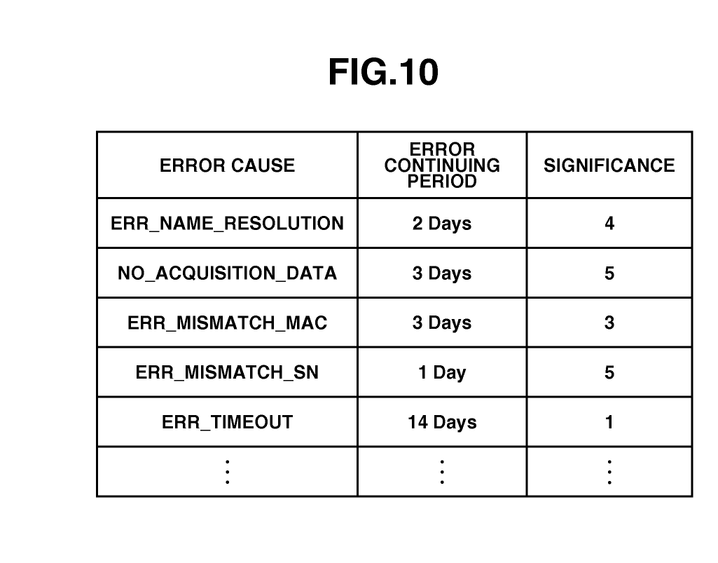

In step S812, the device information management unit 406 acquires a significance of the error cause of which is R and a significance of the error cause of the device information D from a monitoring stop condition list illustrated in FIG. 10.

FIG. 10 illustrates an example of the monitoring stop condition list. In the present exemplary embodiment, the monitoring stop condition list is a list stored beforehand, for example, in the HD 205 of each of the monitoring apparatuses 101 and 111. Alternatively, the device management system can be configured in such a way as to acquire the monitoring stop condition list from the central management apparatus 121.

The monitoring stop condition list illustrated in FIG. 10 includes three items of error cause, error continuing period, and significance. For example, regarding the error cause “ERR_NAME_RESOLUTION” (name resolution error), the significance is “4” and the error continuing period for the monitoring stop is “2 days (2 Days).”

Further, regarding the error cause “ERR_MISMATCH_SN” (serial number inconsistency error), the significance is “5” because a communication destination device is changed and the error continuing period is “1 day (1 Days).”

Further, regarding the error cause “ERR_TIMEOUT” (timeout error), the significance is “1” because it occurs due to power shutdown of the device and the error continuing period is “14 days (14 Days).” In performing the above-mentioned settings, according to the present exemplary embodiment, the setting values (especially, the error continuing period) are changeable depending on a network environment of a client destination. For example, for a client that seldom turns off a device power source, it is feasible to greatly shorten the error continuing period of the timeout error.

As mentioned above, in the present exemplary embodiment, the continuing period corresponding to each error cause is determined based on the significance of the error cause.

The rest of the flowchart illustrated in FIG. 8 will be described.

After the above-mentioned processing in step S812 is completed, then in step S813, the device information management unit 406 compares the significance of the previous error of the device information D with the significance of R (i.e., new error cause). The device information management unit 406 determines whether the significance of R is greater than the significance of the error cause of the device information D (i.e., significance of error cause of D<significance of R).

Then, in a case where the device information management unit 406 determines that the significance of R is greater than the significance of the error cause of the device information D (i.e., significance of error cause of D<significance of R) (YES in step S813), the operation proceeds to step S814.

In step S814, the device information management unit 406 updates the device information D based on the error having a higher significance. More specifically, the device information management unit 406 updates the error cause of the device information D to R, the error occurrence date and time to T, and the last processing date and time to present date and time. Further, the device information management unit 406 updates the in-monitoring-apparatus device list Lc and the database 104 based on the device information D. Then, after the processing in step S814 completes, the operation proceeds to step S807. More specifically, in a case where the error cause of an error occurring in a device is higher in significance than the error cause of an error occurred in the previous monitoring processing, the device information management unit 406 performs a control for the device in such a way as to perform processing in steps S807 and S808 described below (i.e., processing for determining whether the monitoring processing is stopped) with reference to the cause of the error occurring and the occurrence date and time.

On the other hand, in a case where the device information management unit 406 determines that the significance of R is not greater than the significance of the error cause of the device information D (NO in step S813), the operation proceeds to step S815.

In step S815, the device information management unit 406 updates only the last processing date and time of the device information D based on the present date and time because the significance of the previous error is higher. Further, the device information management unit 406 updates the in-monitoring-apparatus device list Lc and the database 104 based on the device information D. Then, after the processing in step S815 completes, the operation proceeds to step S807.

In step S807, namely after completing the above-mentioned processing in steps S806, S814, or S815, the device information management unit 406 acquires an error continuing period C of an error of which cause is the cause of error of the device D from the monitoring stop condition list.

In step S808, the device information management unit 406 calculates the error continuing period by subtracting the last processing date and time of the device information D by the error occurrence date and time. Then, the device information management unit 406 determines whether the error continuing period is greater than C (i.e., last processing date and time of device information D−error occurrence date and time>C).

Then, in a case where the device information management unit 406 determines that the error continuing period is greater than C (i.e., last processing date and time of device information D−error occurrence date and time>C) (YES in step S808), the operation proceeds to step S809.

In step S809, the device information management unit 406 sets the monitoring state of the device information D to “STOPPED” and updates the in-monitoring-apparatus device list Lc and the database 104 based on the device information D. The device, in a case where the monitoring state thereof has been changed to “STOPPED”, is excluded from the monitoring target in step S703 illustrated in FIG. 7. More specifically, the monitoring apparatus performs a subsequent control in such a way as to stop the monitoring processing for the device and disconnect the communication with the device.

In step S810, the device information management unit 406 generates a pseudo-alarm to notify the central management apparatus 121 of the monitoring having been stopped. The pseudo-alarm is one of the failure information, which includes at least monitoring apparatus information, device information, and error information.

In step S811, the device information management unit 406 transmits the above-mentioned pseudo-alarm generated in step S810 to the central management apparatus 121. Then, the device information management unit 406 terminates the device information update processing of the flowchart illustrated in FIG. 8. Namely, in a case where the monitoring apparatuses 101 and 111 identify an image forming apparatus that satisfies predetermined conditions based on the error state and the error continuing period, as a result of the monitoring processing, the monitoring apparatuses 101 and 111 generate the failure information (i.e., the pseudo alarm) indicating a failure of the image forming apparatus and transmit the generated failure information to the central management apparatus 121.

Further, in the above-mentioned step S808, in a case where it is determined that the error continuing period is not greater than C (NO in step S808), the device information management unit 406 terminates the device information update processing of the flowchart illustrated in FIG. 8.

In the present exemplary embodiment, similar effects will be obtained even if the above-mentioned transmission of the pseudo-alarm to the central management apparatus 121 is replaced by mail notification or UI display to a registered user (e.g., the administrator). Further, it may be useful to perform the transmission of the pseudo alarm together with the mail notification or the UI display to the registered user (e.g., the administrator).

As mentioned above, according to the control in the first exemplary embodiment, the monitoring apparatus determines the monitoring stop based on the error state and the error continuing period in the device monitoring for the image forming apparatus and does not perform the communication with the monitoring stopped device. Thus, even in a case where the monitoring apparatus acquires information about a monitoring target device from the central management apparatus 121 and performs monitoring processing for the target device, it is feasible to suppress useless communications for a monitoring-free device being in a registered state in the central management apparatus 121. Accordingly, the monitoring apparatus can suppress the network load from increasing due to useless communications for the monitoring-free device. In addition, the processing delay that may be induced by excessive processing load or timeout can be suppressed. As a result, it becomes feasible to eliminate the occurrence of a phenomenon that the monitoring for a device is delayed due to the processing delay.

Further, a registration error in the central management apparatus 121 may induce a communication disabled state. Even in such a case, generating the pseudo alarm or sending the notification to the administrator will be useful to correct the registration. As mentioned above, it is feasible to flexibly solve the problem (e.g., registration error of a network device) having occurred in the central management apparatus 121.

Accordingly, the monitoring apparatus can reduce the communication load and the processing load. In other words, the processing delay induced by the communication load/processing load can be reduced.

In the above-mentioned first exemplary embodiment, monitoring target device information is acquired from the central management apparatus 121 to update the device information in the monitoring apparatuses 101 and 111. According to the configuration described in the first exemplary embodiment, the monitoring apparatus will be forced to stop the device monitoring processing for a maximum acquisition period after a service engineer or an administrator has removed the error cause by changing settings for the central management apparatus 121. However, the usability will be improved if the monitoring apparatus can restart the monitoring processing immediately after the service engineer or the administrator has removed the error cause. Therefore, in a second exemplary embodiment, the monitoring apparatus is configured to include a user interface (UI) that enables a user to edit the device information or perform a communication test with the device to restart the monitoring processing.

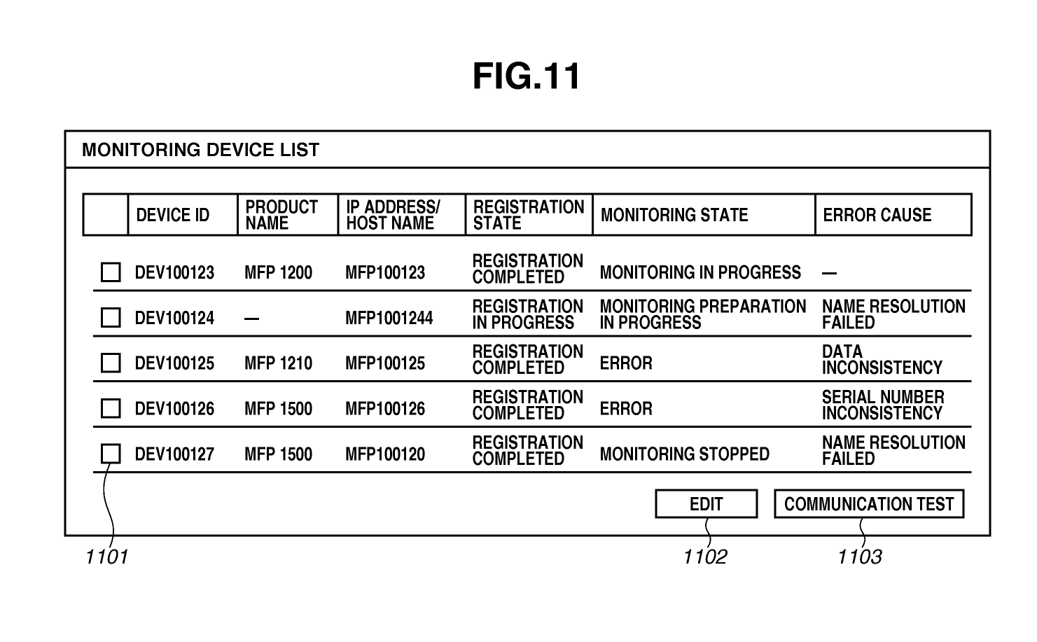

FIG. 11 illustrates an example of a monitoring target device list screen (i.e., the UI) that can be provided by the monitoring apparatuses 101 and 111. The device monitoring unit 407 displays the monitoring target device list screen on the display device 207 of each of the monitoring apparatuses 101 and 111 based on the device information acquired from the in-monitoring-apparatus device list Lc.

According to the monitoring target device list screen illustrated in FIG. 11, each monitoring target device is displayed together with relevant information. A user can edit changeable device information and perform a communication test with the device.

More specifically, the user checks a checkbox 1101 positioned on the left side of each target device and then press an [edit] button 1102 to edit the device information. Further, the user checks the checkbox 1101 of a target device and presses a [communication test] button 1103 to cause the monitoring apparatuses 101 and 111 to perform a communication test with the target device.

For example, a device is brought into a monitoring stop state if the communication is disabled for a predetermined period of time, for example, due to a failure of the device. However, when the device is restored to a monitoring/communication feasible state, the monitoring processing can be restarted if the communication test performed by the user pressing the [communication test] button 1103 has been successfully completed.

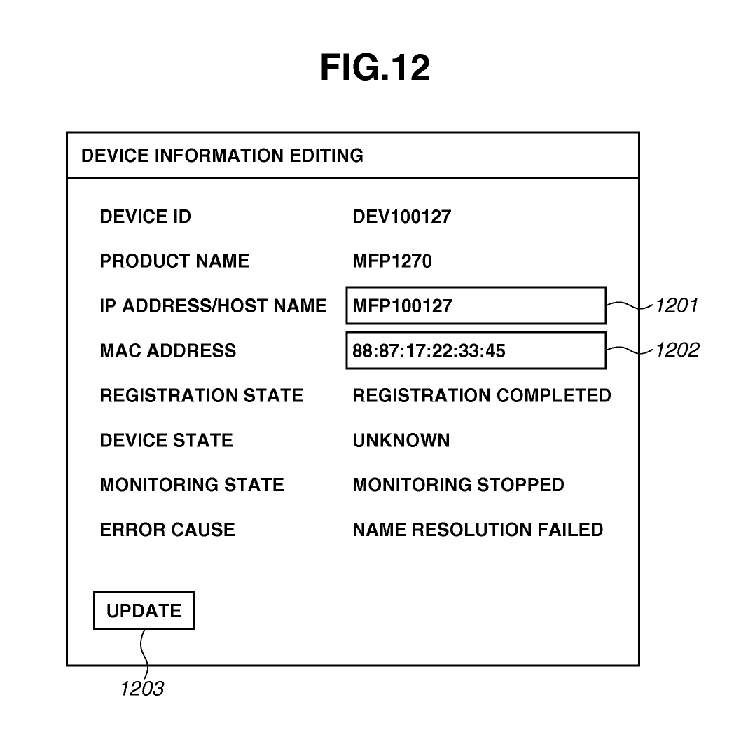

FIG. 12 illustrates an example of a device information editing screen that is displayable in response to a pressing of the [edit] button 1102. The device information editing screen is displayed on the display device 207 of each of the monitoring apparatuses 101 and 111.

According to the example of the device information editing screen illustrated in FIG. 12, IP address/host name and MAC address are changeable in an [IP address/host name] field 1201 and a [MAC address] field 1202. More specifically, the device information editing screen enables a user to update device information managed by the device information management unit 505. For example, when the monitoring is stopped by a typographical error of the host name, the user inputs a correct host name in the [IP address/host name] field 1201 of the device information editing screen and presses an [update] button 1203 to update the in-monitoring-apparatus device list Lc and the device information managed by the device information management unit 505 (i.e., the information in the database 104). If the above-mentioned update processing is successfully completed, the monitoring processing can be restarted for the corresponding device.

The above-mentioned processing will be described in detail below with reference to a flowchart illustrated in FIG. 13.

FIG. 13 is a flowchart illustrating an example of UI processing that can be performed by the monitoring apparatuses 101 and 111. To simplify the description, an operation described below is performed by the monitoring apparatus 101 of the client system 100, although the monitoring apparatus 111 of the client system 110 performs a similar operation. The processing according to the present invention will be chiefly described with reference to the flowchart illustrated in FIG. 13. Redundant description of other processing not relevant to the present invention will be avoided. Further, the present flowchart will be described in detail below only for the processing different from that illustrated in FIG. 7, and redundant description of similar processing will be avoided.

In step S1301, the device monitoring unit 407 performs program initialization processing and UI initialization processing. More specifically, the device monitoring unit 407 displays the monitoring target device list screen illustrated in FIG. 11.

In step S1302, the device monitoring unit 407 determines whether an update instruction has been input. More specifically, the device monitoring unit 407 determines whether the [update] button 1203 illustrated in FIG. 12 has been pressed via the input device 206.

In a case where the device monitoring unit 407 determines that the update instruction has been input (YES in step S1302), the operation proceeds to step S1303.

In step S1303, the device monitoring unit 407 resets the device information of the target device (i.e., the device for which update has been instructed). Similar to step S726 illustrated in FIG. 7, the device monitoring unit 407 resets the update information, the monitoring state, the error cause, the error occurrence date and time, and the last processing date and time. Subsequently, the operation proceeds to step S1304.

Further, in the above-mentioned step S1302, in a case where the device monitoring unit 407 determines that the update instruction has not been input (NO in step S1302), the operation proceeds to step S1312.

In step S1312, the device monitoring unit 407 determines whether a communication test instruction has been input. More specifically, the device monitoring unit 407 determines whether the [communication test] button 1103 illustrated in FIG. 11 has been pressed.

In a case where it is determined that the communication test instruction has been input (YES in step S1312), the device monitoring unit 407 designates the device of which communication test has been instructed as a target device. Then, the operation proceeds to step S1304.

After the above-mentioned processing in step S1303 or step S1312, then in step S1304, the device monitoring unit 407 acquires the device identification information from the target device. Similar to step S717, the device identification information includes a serial No., a MAC address, and capability information. The above-mentioned target device is the above-mentioned update target device in step S1302 or the communication test target device in step S1312.

In step S1305, the device monitoring unit 407 determines whether the communication with the device has been successfully completed in the above-mentioned acquisition processing in step S1304.

Then, in a case where the device monitoring unit 407 determines that the communication with the device has been successfully completed (YES in step S1305), the operation proceeds to step S1306.

In step S1306, the device monitoring unit 407 determines whether the acquisition data is normal, similar to step S719 illustrated in FIG. 7.

Then, in a case where the device monitoring unit 407 determines that the acquisition data is normal (YES in step S1306), the operation proceeds to step S1307.

In step S1307, the device monitoring unit 407 performs device related initial settings (e.g., event registration for the device).

In step S1308, the device monitoring unit 407 performs target device information update processing (see FIG. 8). Similar to step S721 illustrated in FIG. 7, the device monitoring unit 407 performs the device information update processing using the device ID of the target device, Result=NO_ERR, and error occurrence date and time=NULL, as input parameters.

Further, in the above-mentioned step S1305, in a case where the device monitoring unit 407 determines that the communication with the device has been failed (NO in step S1305), the operation proceeds to step S1310.

Further, in the above-mentioned step S1306, in a case where the device monitoring unit 407 determines that the acquisition data is not normal (NO in step S1306), the operation proceeds to step S1310.

In step S1310, the device monitoring unit 407 sets an appropriate error value to Result.

In step S1311, the device monitoring unit 407 performs the target device information update processing (see FIG. 8). More specifically, the device monitoring unit 407 performs the device information update processing using the device ID of the target device, the above-mentioned Result value having been set in step S1310, and error occurrence date and time=present date and time as input parameters.

After the above-mentioned processing in step S1308 or S1311, then in step S1309, the device monitoring unit 407 updates the UI display. In a case where the device information editing screen (see FIG. 12) is displayed, the device monitoring unit 407 closes the device information editing screen and reopens the monitoring target device list screen (see FIG. 11). The device monitoring unit 407 also updates contents to be displayed on the monitoring target device list screen. After the device monitoring unit 407 completes the above-mentioned processing in step S1309, the operation proceeds to step S1302.

Further, in the above-mentioned step S1312, in a case where the device monitoring unit 407 determines that the communication test instruction has not been input (NO in step S1312), the operation proceeds to step S1313.

In step S1313, the device monitoring unit 407 determines whether an edit instruction has been input. More specifically, the device monitoring unit 407 determines whether the [edit] button 1102 illustrated in FIG. 11 has been pressed.

In a case where the device monitoring unit 407 determines that the edit instruction has been input, more specifically in a case where it is determined that the pressing of the [edit] button has been detected (YES in step S1313), the operation proceeds to step S1314.

In step S1314, the device monitoring unit 407 displays the device information editing screen illustrated in FIG. 12. Then, the operation proceeds to step S1302.

On the other hand, in the above-mentioned step S1313, in a case where the device monitoring unit 407 determines that the edit instruction has not been input (NO in step S1313), the operation proceeds to step S1315.

In step S1315, the device monitoring unit 407 appropriately performs other processing. Then, the operation proceeds to step S1302. The processing to be performed in step S1315 is not relevant to the present invention and redundant description thereof will be avoided.

The device management system according to the present exemplary embodiment can be configured to update not only the device information managed by each monitoring apparatus but also the device information managed by the central management apparatus 121 in response to the above-mentioned update instruction.

As mentioned above, according to the second exemplary embodiment, it is feasible to obtain the effects of the first exemplary embodiment. In addition, after a service engineer or an administrator has changed settings to remove the error cause, it is feasible to promptly restart the processing for monitoring the device relating to the changed settings. Therefore, it is feasible to reduce the delay in the monitoring processing and improve the operability.

As mentioned above, the monitoring apparatus installed in the client environment determines to provisionally stop the device monitoring processing based on the error state and the continuing period of each error, without an instruction from the central management apparatus 121. The monitoring apparatus does not communicate with the monitoring stopped device, while the registration of the monitoring-free device is maintained in the central management apparatus 121. Since the monitoring apparatus stops monitoring the monitoring-free device, the monitoring apparatus can reduce the communication load and the processing load and can reduce the processing delay induced by the communication load/processing load. The monitoring apparatus generates a pseudo-alarm when the monitoring processing is stopped, and transmits the pseudo-alarm to the central management apparatus 121. Therefore, the administrator and the service engineer can recognize the state where the monitoring apparatus has stopped the monitoring for a specific device. Accordingly, it is feasible to flexibly solve the problem (e.g., registration error of a network device) having occurred in the central management apparatus 121.

As described in each of the above-mentioned exemplary embodiments, the device management system is configured to update the in-monitoring-apparatus device list Lc and the information stored in the database 104 when the device information of the monitoring apparatus is updated. However, it is unnecessary to simultaneously update the in-monitoring-apparatus device list Lc and the information of the database 104. For example, it is feasible to update the information stored in the database 104 based on only the in-monitoring-apparatus device list Lc at timing different from that of the in-monitoring-apparatus device list Lc.

The monitoring targets of the monitoring apparatus having been described in the above-mentioned exemplary embodiments are image forming apparatuses (e.g., printing apparatuses). However, any other network device can be a monitoring target of the monitoring apparatus.

For example, the monitoring apparatus can perform a monitoring operation for any other network device (e.g., a personal computer, a network consumer electronics apparatus, a digital medical device, or a network camera).

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-172785, filed Aug. 27, 2014, which is hereby incorporated by reference herein in its entirety.

What is claimed is:

1. A monitoring apparatus comprising:
an acquisition unit configured to acquire a list including a plurality of network devices to be a monitoring target from a management apparatus that manages registration information about a plurality of network devices to be a management target;
a monitoring unit configured to acquire device information from the plurality of network devices included in the list and perform monitoring processing;
a first transmission unit configured to transmit at least a part of the device information acquired for the monitoring processing to the management apparatus;
a generation unit configured to generate, in a case where a network device satisfying a predetermined condition is identified according to a result of the monitoring processing, failure information as failure of the identified network device;
a second transmission unit configured to transmit the failure information generated by the generation unit to the management apparatus; and
a stop unit configured to stop the monitoring processing for the network device corresponding to the generated failure information based on the predetermined condition.

2. The monitoring apparatus according to claim 1, wherein the network device satisfying the predetermined condition is a network device of which error in the monitoring processing continues in excess of a continuing period corresponding to a cause of the error.

3. The monitoring apparatus according to claim 2, wherein the continuing period corresponding to the cause of the error is a continuing period corresponding to a significance of the cause of the error.

4. The monitoring apparatus according to claim 2,
wherein the device information includes information about the cause of the error, error occurrence date and time, and last processing date and time of in a case where a communication result or an acquisition result in the monitoring processing is error, and
wherein the generation unit is configured to identify the network device satisfying the predetermined condition based on the device information and information about a continuing period corresponding to the cause of the error included in the device information.

5. The monitoring apparatus according to claim 2, wherein the generation unit is configured to determine, in a case where a cause of an error occurring in a network device has a higher significance than a cause of an error occurred in previous monitoring processing, the predetermined condition for the network device with reference to the cause of the error occurring and the occurrence date and time.

6. The monitoring apparatus according to claim 1, wherein, in a case where the information acquired by the acquisition unit includes update information about information of a network device for which the monitoring processing has been stopped, the monitoring unit restarts the monitoring processing for the network device.

7. The monitoring apparatus according to claim 1, further comprising:
a management unit configured to manage information about the plurality of network devices included in the list; and
an update unit configured to update the information managed by the management unit according to a user input,
wherein, in a case where the update unit updates information about a network device for which the monitoring processing has been stopped, the monitoring unit restarts the monitoring processing for the network device.

8. The monitoring apparatus according to claim 1, further comprising:
a test unit configured to communicate with the network device for which monitoring processing has been stopped according to a user instruction,
wherein, in a case where the test unit successfully completes the communication with the network device for which the monitoring processing has been stopped, the monitoring unit restarts the monitoring processing for the network device.

9. The monitoring apparatus according to claim 1, wherein the network device is an image forming apparatus.

10. A method for a monitoring apparatus, the method comprising:
acquiring a list including a plurality of network devices to be a monitoring target from a management apparatus that manages registration information about a plurality of network devices to be a management target;
acquiring device information from the plurality of network devices included in the list and performing monitoring processing;
transmitting, as a first transmitting, at least a part of the device information acquired for the monitoring processing to the management apparatus;
generating, in a case where a network device satisfying a predetermined condition is identified according to a result of the monitoring processing, failure information as failure of the identified network device;
transmitting, as a second transmitting, the generated failure information to the management apparatus; and
stopping the monitoring processing for the network device corresponding to the generated failure information based on the predetermined condition.

11. A computer readable storage medium storing a computer program to cause a computer to execute a method for a monitoring apparatus, the method comprising:
acquiring a list including a plurality of network devices to be a monitoring target from a management apparatus that manages registration information about a plurality of network devices to be a management target;
acquiring device information from the plurality of network devices included in the list and performing monitoring processing;
transmitting, as a first transmitting, at least a part of the device information acquired for the monitoring processing to the management apparatus;
generating, in a case where a network device satisfying a predetermined condition is identified according to a result of the monitoring processing, failure information as failure of the identified network device;
transmitting, as a second transmitting, the generated failure information to the management apparatus; and
stopping the monitoring processing for the network device corresponding to the generated failure information based on the predetermined condition.
